(19) United States
(12) Patent Application Publication
(10) Pub. No.: US 2014/0001407 A1
(43) Pub. Date: Jan. 2, 2014

(54) HIGH-PRESSURE PROCESS FOR THE CARBON DIOXIDE REFORMING OF HYDROCARBONS IN THE PRESENCE OF IRIDIUM-COMPRISING ACTIVE COMPOSITIONS

(71) Applicant: BASF SE, Ludwigshafen (DE)

(72) Inventors: Andrian MILANOV, Mannheim (DE); Ekkehard Schwab, Neustadt (DE); Stephan Schunk, Heidelberg (DE); Guido Wasserschaff, Neckargemuend (DE)

(21) Appl. No.: 13/930,422

(22) Filed: Jun. 28, 2013

Related U.S. Application Data
(60) Provisional application No. 61/665,896, filed on Jun. 29, 2012.

(51) Int. Cl. B01J 23/63; C01B 3/26

(52) U.S. Cl. CPC B01J 23/63; C01B 3/26
USPC 252/373; 502/325; 502/302; 502/303; 502/339; 502/330; 502/326; 502/308; 502/324; 502/328; 502/332

(57) ABSTRACT

The invention relates to a catalytic high-pressure process for the CO₂ reforming of hydrocarbons, preferably methane, in the presence of iridium-comprising active compositions and also a preferred active composition in which Ir is present in finely dispersed form on zirconium dioxide-comprising support material. The predominant proportion of the zirconium dioxide preferably has a cubic and/or tetragonal structure and the zirconium dioxide is more preferably stabilized by means of at least one doping element. In the process of the invention, reforming gas is brought into contact at a pressure of greater than 5 bar, preferably greater than 10 bar and more preferably greater than 20 bar, and a temperature which is in the range from 600 to 1200° C., preferably in the range from 850 to 1100° C. and in particular in the range from 850 to 950° C., and converted into synthesis gas. The process of the invention is carried out using a reforming gas which comprises only small amounts of water vapor or is completely free of water vapor. In the process, the formation of carbonaceous material on the catalyst is greatly suppressed while carrying out the process, as a result of which the process can be carried out over a long period of time without significant decreases in activity occurring.

The present invention relates to a high-pressure process for the carbon dioxide reforming of hydrocarbons using iridium-comprising active compositions. The utilization of carbon dioxide as reagent in chemical processes is of great economic and industrial importance in order to reduce the emission of carbon dioxide into the atmosphere.

Numerous scientific publications and patents relate to the preparation of synthesis gas. It is known that noble metal-comprising catalysts can be used for the carbon dioxide reforming of methane (also known as dry reforming).

In the following part, an overview of the prior art in the field of carbon dioxide reforming of methane is given.

An overview of carbon dioxide reforming of methane is given in a publication by Bradford et al. (M. C. J. Bradford, M. A. Vannice; Cataly. Rev.-Sci. Eng., 41 (1) (1999) p. 1-42).

U.S. Pat. No. 6,749,828 discloses a catalyst in which ruthenium has been deposited on zirconium dioxide or a ruthenium salt has been added in order to precipitate zirconium-comprising species. The catalyst leads to high yields in the conversion of reforming gas comprising carbon dioxide. In addition, only small amounts of carbonaceous deposits are formed on the catalyst. The experimental examples describe catalysis tests carried out at pressures of 0.98 bar and 4.9 bar. In one test (i.e. example 6), the temperatures were 1000° C. Otherwise, the tests were carried out at temperatures of from 780 to 800° C. Furthermore, it is disclosed that the catalytic tests were carried out in the presence of steam, with a steam/carbon ratio of from 0.1 to 10 being considered to be typical and a steam/carbon ratio of from 0.4 to 4 being preferred.

US 2005/0169835 A1 discloses a process in which reforming gas is reacted with carbon dioxide and methane over a catalyst comprising more than 50% by weight of silicon carbide in the beta form as support material. Apart from the silicon carbide support material, the catalyst can further comprise noble metals or nickel in a proportion of from 0.1 to 10% as active components. Possible noble metals are Rh, Ru, Pt or Ir and mixtures thereof.

U.S. Pat. No. 5,753,143 discloses a catalytic process for the reforming of carbon dioxide in the presence of methane, with the process being able to be carried out in the absence of steam. A zeolite having Rh as active component is disclosed as catalyst.

U.S. Pat. No. 7,166,268 discloses a steam reforming process for preparing hydrogen or synthesis gas, in which the catalyst comprises a crystalline alumina comprising CeO₂ as support and ruthenium and cobalt as active components are distributed on the support. The process can also be used for the carbon dioxide reforming of hydrocarbons.

EP 1 380 341 discloses a process for the reforming of hydrocarbons by means of a steam reforming process. The active components are elements selected from the group consisting of Ru, Pt, Rh, Pd, Ir and Ni. The support for the active components comprises alumina and from 5 to 95% by weight of manganese oxide.

U.S. Pat. No. 7,309,480 discloses and claims a catalyst for producing hydrogen which comprises a catalyst support comprising monoclinic zirconium oxide on which Ir is present in dispersed form.

One of the objects of the invention was to provide a catalytic process for the production of synthesis gas, which has a high energy efficiency compared to the processes known in the prior art. A further object was to provide a catalytic process by means of which carbon dioxide can be chemically converted. The object of the invention relates to both the development of a suitable catalyst and the development of a suitable reforming process.

The objects mentioned here and further objects which are not mentioned here are achieved by provision of a reforming process and a catalyst for the reforming of hydrocarbons, preferably methane, in the presence of CO₂; firstly the catalyst according to the invention and then the reforming process of the invention will be described in more detail below.

### I. Reforming Catalyst

The invention relates to a catalyst for the CO₂ reforming of hydrocarbons, preferably methane, having an active composition which comprises at least iridium as active component and zirconium dioxide-comprising support material, wherein

a) the Ir content based on the zirconium dioxide-comprising active composition is in the range 0.01-10% by weight, preferably 0.05-5% by weight and more preferably 0.1-1% by weight, and

b) the zirconium dioxide in the zirconium dioxide-comprising support material is, according to X-ray-diffractometric analysis, predominantly present in the cubic and/or tetragonal structural form, where the proportion of cubic and/or tetragonal phase is >50% by weight, more preferably >70% by weight and in particular >90% by weight.

In a preferred embodiment of the catalyst of the invention, the zirconium dioxide-comprising active composition has a specific surface area of >5 m²/g, preferably >20 m²/g, more preferably 50 m²/g and in particular >80 m²/g. The determination of the specific surface area of the catalyst was carried out by gas adsorption using the BET method (ISO 9277:1995).

It is particularly advantageous for the iridium to be present in finely dispersed form on the zirconium dioxide support, since a high catalytic activity is achieved at a low content of Ir in this way.

In a preferred embodiment of the catalyst of the invention, the Ir is present on the zirconium dioxide-comprising support and the latter is doped with further elements. For doping the zirconium dioxide support, preference is given to selecting elements from the group of the rare earths (i.e. from the group consisting of Sc, Y, La, Ce, Pr, Nd, Sm, Eu, Gd, Tb, Dy, Ho, Er, Tm, Yb, Lu), group IIa (i.e. from the group consisting of Mg, Ca, Sr, Ba), group IVa (i.e. from the group consisting of Si), group IVb (i.e. from the group consisting of Ti, Hf), group Vb (i.e. from the group consisting of V, Nb, Ta) of the Periodic Table and oxides thereof.

Further doping elements can be, inter alia: platinum metals such as Pt, Pd, Ru, Rh, base metals such as Ni, Co and Fe, other metals such as Mn or other promoters known to those skilled in the art.

If the catalyst comprises one or more doping elements from the group of the rare earths in addition to Ir and zirconium dioxide, the proportion by weight of doping elements based on the total weight of the catalyst is in the range from 0.01 to 80% by weight, preferably in the range from 0.1 to 50% by weight and in particular in the range from 1.0 to 30% by weight.

Without restricting the invention by theoretical considerations, it is assumed that the doping of the active composition with one or more of the abovementioned elements leads to stabilization of the tetragonal or cubic phase of the zirconium dioxide. Furthermore, it can be presumed that the ion-conducting properties or redox properties of the zirconium dioxide support are influenced by doping. The influence of these properties on the activity of the catalyst for the reforming of methane in the presence of CO₂ at high temperatures, high pressures and very low steam-to-methane ratios appear to be significant.

In a particularly preferred embodiment, the active composition according to the invention comprises not only iridium and zirconium dioxide but also yttrium as further doping element, with the yttrium being present in oxidic form. The yttrium oxide content based on ZrO₂ is preferably in the range from 0.01-80% by weight, more preferably 0.1-50% by weight and even more preferably 1.0-30% by weight. Doping with yttrium leads to stabilization of the cubic or tetragonal phase of ZrO₂.

In a further and preferred embodiment, the active composition according to the invention comprises not only iridium and zirconium dioxide but additionally two elements from the group of the rare earths as doping elements. The content of doping elements based on the content of ZrO₂ is preferably in the range 0.01-80% by weight, more preferably 0.1-50% by weight and even more preferably 1.0-30% by weight. Particular preference is given to using lanthanum (La) and cerium (Ce) as doping elements.

Doping with lanthanum and cerium leads to stabilization of the cubic or tetragonal phase of ZrO₂ resembling the stabilization by yttrium, with La—Zr oxide, Ce—Zr oxide and Ce—La—Zr oxide phases being able to be partially formed. In the catalyst of the invention, the total proportion of the cubic and tetragonal zirconium dioxide-comprising phase based on zirconium dioxide present is preferably >60% by weight, more preferably >70% by weight and even more preferably >80% by weight.

It has surprisingly been found that the catalysts according to the invention in which the iridium has been deposited on zirconium dioxide and the zirconium dioxide predominantly has a tetragonal and/or cubic structure display significantly greater operating lives and improved resistance to formation of carbonaceous deposits than corresponding catalysts which have other noble metal-comprising active components and corresponding catalysts in which iridium-comprising species are in contact with zirconium dioxide which has a monoclinic structure.

Very particular preference is given to catalysts according to the invention which comprise Ir/ZrO₂ active compositions in which the zirconium dioxide is doped with yttrium or doped with lanthanum and/or cerium.

In further embodiments, the active compositions according to the invention which are used for the process of the invention additionally comprise promoters and/or further metal cations which further increase the efficiency of the catalysts.

In a preferred embodiment, the catalyst of the invention or the active composition comprises at least one noble metal-comprising promoter from the group consisting of Pt, Rh, Pd, Ru, Au, where the proportion of noble metal-comprising promoters based on the catalyst is 0.01-5% by weight and more preferably in the range 0.1-3% by weight.

In a further preferred embodiment, the catalyst comprises at least one base metal-comprising promoter from the group consisting of Ni, Co, Fe, Mn, Mo, W, where the proportion of base metal-comprising promoters based on the weight of the catalyst is in the range 0.1-50% by weight, preferably in the range 0.5-30% by weight and more preferably in the range 1-20% by weight.

In a further embodiment, the catalyst additionally comprises a proportion of further metal cations which are preferably selected from the group consisting of Mg, Ca, Sr, Ba, Ga, Be, Cr, Mn, with Ca and Mg being particularly preferred.

The components present in the catalyst of the invention, i.e. the abovementioned noble metals, alkaline earth metals, doping elements, promoters and support materials, can be present in elemental and/or oxidic form.

It should be noted that the invention is not intended to be restricted to the combinations and value ranges indicated in the description, but other combinations of the components within the limits of the main claim are also conceivable and possible.

The catalyst of the invention can be produced by impregnation coating of the support material with the individual components. In a further and advantageous embodiment of the production process, the active components are applied to pulverulent support material which is subsequently at least partially kneaded and extruded.

It is also possible for different production processes to be combined with one another and, for example, only part of the active components to be applied to and kneaded with the pulverulent support material. For example, a combination of kneading and extrusion is also possible in order firstly to bring part of the starting components into contact and subsequently carry out the deposition of the remaining components by means of impregnation coating.

The process for producing the active compositions according to the invention is not restricted in any way, but it is instead possible to use quite different process steps. Thus, the term of application is not to be considered as a restriction for the purposes of the present disclosure and in respect of the active components. The term application thus also comprises contacting of starting components, the active components and zirconium-comprising species. The zirconium-comprising species can also be present as precursor materials which are converted into the material according to the invention only during the synthesis process.

For example, production of the active composition by coprecipitation of active component and zirconium-comprising species in combination with a thermal treatment process is not ruled out. In the case of such a synthesis process, it is possible for the zirconium-comprising species to be converted into the zirconium dioxide having the cubic and/or tetragonal structure only during the thermal treatment. Further examples for synthesis processes are flame-pyrolytic processes or plasma processes.

In this context, it may also be said that application of active components in the sense of impregnation onto the zirconium dioxide-comprising support material is particularly preferred when the zirconium dioxide within the support material is already present in the cubic and/or tetragonal structural form.

To apply the active components to the support, preference is given to metal compounds which are soluble in solvents. Solvents which are preferably used include, inter alia, the following: water, acidic or alkaline aqueous solutions, alcohols such as methanol, ethanol, propanol, isopropanol, butanol, ketones such as acetone or methyl ethyl ketone, aromatic solvents such as toluene or xylenes, aliphatic solvents such as cyclohexane or n-hexane, ethers and polyethers such as tetrahydrofuran, diethyl ether or diglyme, esters such as methyl acetate or ethyl acetate.

As metal compounds, particular preference is given to using soluble salts, complexes or metal-organic compounds. Examples of salts are, inter alia, halides, carbonyls, acetates, nitrates, carbonates. Examples of complexes are, inter alia, bipyridyl complexes, acetonitrile complexes, carbonyl complexes, complexes with amino acids or amines, complexes with polyols or polyacids, complexes with phosphanes. Examples of metal-organic compounds are, inter alia, acetylacetonates, alkoxides, amides, alkyl compounds, cyclopentadienyls and cycloalkanes.

Furthermore, sols comprising colloidal particles in metallic or oxidic form are also used as starting materials. Such colloidal particles can be stabilized by means of stabilizing agents and/or special treatment methods, for example by means of surface-active agents.

In a preferred embodiment, the catalyst has an active composition comprising an yttrium-stabilized zirconium dioxide and an iridium-comprising active component, where the iridium-comprising active component is present in finely divided form and the iridium-comprising particles have a size of <30 nm, preferably <20 nm and more preferably <10 nm.

The present invention also provides a process for producing the catalyst of the invention, in which at least one noble metal, particularly preferably iridium, is applied to the support material comprising cubic and/or tetragonal zirconium dioxide and at least one doping element selected from the group of rare earths, particularly preferably yttrium.

As process for applying the active components to the support material, it is possible to use all processes which are known to a person skilled in the art in the field of catalyst production. Mention may be made here by way of example of impregnation with an impregnation solution, impregnation to pore volume, spraying-on of the impregnation solution, washcoating and precipitation. In the case of impregnation to pore volume, a defined amount of impregnation solution which is sufficient for filling the pore volume of the support material and leaves the support material with the appearance of a dry state is added to the support material.

In an advantageous embodiment, the active component, and also optionally the promoters and further metal cations, is firstly applied at least partly to a pulverulent support material, kneaded and subsequently extruded. Kneading and extrusion of the support material together with the active components is carried out using apparatuses known to those skilled in the art.

The production of shaped bodies from pulverulent raw materials can be carried out by methods known to those skilled in the art, for example tableting, aggregation or extrusion, as described, inter alia, in Handbook of Heterogeneous Catalysis, Vol. 1, VCH Verlagsgesellschaft Weinheim, 1997, pp 414-417.

Auxiliaries can be added to the synthesis system. The addition of auxiliaries can be carried out, for example, during shaping or during application of the active component to the support. Auxiliaries which can be used are, for example, binders, lubricants and/or solvents. The auxiliaries added to the synthesis system are then converted by thermal treatment into the other constituents which can form additional components. The additional components are generally oxidic materials, some of which may function as bonding sites and thereby contribute to increasing the mechanical stability of the shaped body or of the individual particles. The binders can, for example, comprise species comprising aluminum hydroxide, silicon hydroxide or magnesium hydroxide.

The iridium-comprising active composition can also have been applied to a support, monolith or honeycomb body. The monolith or honeycomb body can comprise metal or ceramic. The molding of the active composition or the application of the active composition to a support or support bodies is of great technical importance for the fields of application of the catalyst of the invention. Depending on particle size and reactor packing, the shape of the particles has an effect on the pressure drop brought about by the fixed catalyst bed.

A characteristic of the process of the invention for the reforming of hydrocarbons, preferably methane, in the presence of CO₂ is that it is possible to use ZrO₂-comprising active compositions which have a relatively low content of Ir and nevertheless have a high catalytic efficiency. Thus, it is also possible, for example, to achieve high conversions using active compositions which have, for example, only 1% by weight or less than 1% by weight of Ir.

### II. CO₂ Reforming Process

The present invention provides a catalytic high-pressure process for the carbon dioxide reforming of hydrocarbons, preferably methane, to produce synthesis gas, wherein:

(i) the CO₂-comprising reforming gas is brought into contact with an iridium-comprising active composition, where the total content of hydrocarbons, preferably CH₄, and CO₂ in the reforming gas is greater than 80% by volume, preferably greater than 85% by volume and more preferably greater than 90% by volume,

(ii) the pressure of the reforming gas on contacting with the active composition is in the range 5-500 bar, preferably in the range from 10 to 250 bar and more preferably in the range from 20 to 100 bar, and the temperature of the reforming gas on contacting with the active composition is in the range from 600 to 1200° C., preferably in the range from 850 to 1100° C. and in particular in the range from 850 to 950° C.,

(iii) the GHSV in the process is in the range from 500 to 100 000 h⁻¹, preferably in the range from 500 to 50 000 h⁻¹,

(iv) the synthesis gas produced has an H₂/CO ratio in the range from 0.4 to 1.8, more preferably in the range from 0.5 to 1.4 and in particular in the range from 0.8 to 1.2.

In a preferred embodiment of the process, the iridium is present in combination with zirconium dioxide in the iridium-comprising active composition and the Ir content based on ZrO₂ is in the range 0.01-10% by weight, preferably 0.05-5% by weight and more preferably 0.1-1% by weight.

In a preferred embodiment of the process, the active composition comprises zirconium dioxide as support material, where the zirconium dioxide predominantly has a cubic and/or tetragonal structure and the proportion of cubic and/or tetragonal phase is >50% by weight, more preferably >70% by weight and in particular >90% by weight.

A characteristic of the catalyst of the invention and the process of the invention is a high activity in respect of the carbon dioxide reforming of hydrocarbons, preferably methane, in the presence of CO₂. A further characteristic of the process of the invention is the excellent resistance to formation of carbonaceous deposits under very severe reaction conditions. With regard to the severe reaction conditions, particular mention may be made of a high pressure and temperature resistance at low steam-to-carbon ratios (S/C). The technical effect brought about thereby results in high operating lives of the catalyst when carrying out the process of the invention.

In a further preferred embodiment, the active composition comprises not only iridium and zirconium dioxide but also at least one doping element selected from the group of rare earths (Sc, Y, La, Ce, Pr, Nd, Sm, Eu, Gd, Tb, Dy, Ho, Er, Tm, Yb, Lu), particularly preferably yttrium, where the content based on ZrO₂ is in the range 0.01-80% by weight, preferably 0.1-50% by weight and more preferably 1.0-30% by weight.

In order to increase the performance properties in the reforming reaction, the catalyst used in the process of the invention can additionally comprise noble metal-comprising promoters, base metal-comprising promoters and also further metal cations.

The noble metal promoters are selected from the group consisting of Pt, Rh, Pd, Ru, Au, where the proportion of noble metal-comprising promoters, based on the weight of the catalyst, is in the range 0.01-5% by weight and more preferably in the range 0.1-3% by weight.

The base metal-comprising promoters are selected from the group consisting of Ni, Co, Fe, Mn, Mo, W, where, based on the weight of the catalyst, the proportion of base metal-comprising promoters is in the range 0.1-50% by weight, preferably in the range 0.5-30% by weight and more preferably in the range 1-20% by weight.

The metal cations are preferably one or more elements selected from the group consisting of Mg, Ca, Sr, Ga, Be, Cr and Mn, with particular preference being given to Ca and/or Mg.

Another advantage of the process of the invention is that the process of the invention can be carried out using a feed fluid having small amounts of steam or no steam at all. In a preferred embodiment, the steam/carbon ratio in the reforming gas is less than 0.2, more preferably less than 0.1 and even more preferably less than 0.05.

In addition, it is even possible in connection with the process of the invention and in particular embodiments even preferred for a reforming gas which is largely water-free or comprises no water to be used.

Carrying out the process of the invention at low water contents offers the advantage of a high energetic efficiency of the process and simplification of the process flow diagram of a plant in which the process of the invention is utilized.

When carrying out the process of the invention, the iridium-comprising active component is subjected to severe physical and chemical stress since the process is carried out at a temperature in the range from 600 to 1200° C., preferably from 850 to 1100° C. and more preferably in the range from 850 to 950° C., with the process pressure being in the range from 5 to 500 bar, preferably in the range from 10 to 250 bar and more preferably in the range from 20 to 100 bar. Although the process is carried out under very severe process conditions, deposition of carbonaceous material on the catalyst can be largely ruled out due to the specific properties of the material according to the invention, which also represents an advantage of the process of the invention.

Owing to the low level of carbonaceous deposits, the process of the invention can be carried on over a long period of time, which is once again advantageous in terms of process efficiency.

### III. Examples

To illustrate the invention, a number of examples of the production and use of the reforming catalysts of the invention are presented. In addition, comparative examples which correspond to the prior art and thus do not have the features according to the invention are described.

### 1. Production of the Iridium-Comprising Catalysts

To produce the catalyst (S2) according to the invention, 198 g of yttrium-stabilized zirconium dioxide were impregnated with an aqueous iridium chloride solution. To produce the iridium chloride solution, 3.84 g of IrCl₄*H₂O were firstly dissolved in 20 ml of distilled water and the solution was made up with water. The amount of water was selected in such a way that 90% of the free pore volume of the support oxide could be filled with the solution. The free pore volume was 0.2 cm³/g. The yttrium-stabilized zirconium dioxide had an yttrium oxide content (Y₂O₃) of 8% by weight and was present as crushed material having a particle size in the range 0.5-1.0 mm.

The crushed material composed of stabilized support oxide was placed in an impregnation drum and spray-impregnated with the iridium chloride solution while rotating the drum. After impregnation, the material was rotated for a further 10 minutes and subsequently dried at 120° C. in a convection drying oven for 16 hours. Calcination of the dried material was carried out at 550° C. for two hours.

The iridium-comprising catalyst S2 obtained in this way had an iridium content of 1.0 g of iridium per 100 g of catalyst.

### 2. Production of Comparative Platinum Catalyst

The platinum-comprising comparative catalyst CE5 was produced by the same process as the iridium catalyst S2 using a cerium/lanthanum-doped zirconium dioxide as support oxide. The support oxide had a free pore volume of 0.21 cm³/g and a rare earth content of La oxide and Ce oxide of 22% by weight. 100 g of support oxide in the form of crushed material having a particle size in the range from 0.5 to 1.0 mm were used for impregnation. To carry out the impregnation, 6.37 g of platinum nitrate salt (comprising 15.7% by weight of platinum) were dissolved in water and the solution was subsequently sprayed onto the support oxide in a spray drum. The comparative catalyst CE5 obtained after impregnation had a Pt content of 1.0 g of Pt/100 g of catalyst.

A summary of the active compositions examined is shown in table 1. All active compositions shown in the table were produced in the laboratory by means of an impregnation process using a rotating impregnation drum.

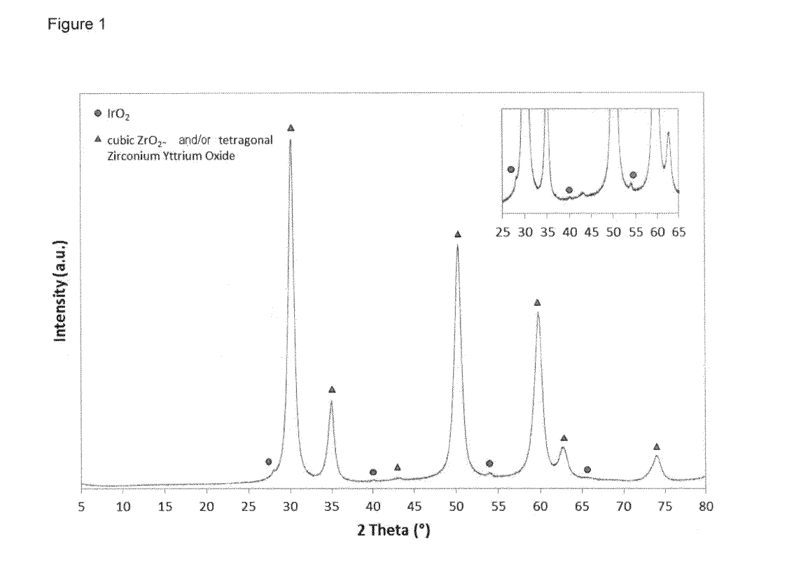

FIG. 1 shows the X-ray diffraction pattern recorded on catalyst sample S2 before the reductive treatment. In the upper part of the figure, there is an enlargement of the angle range from 25° 2theta to 65° 2theta to highlight the reflections which can be assigned to the iridium-comprising phase.

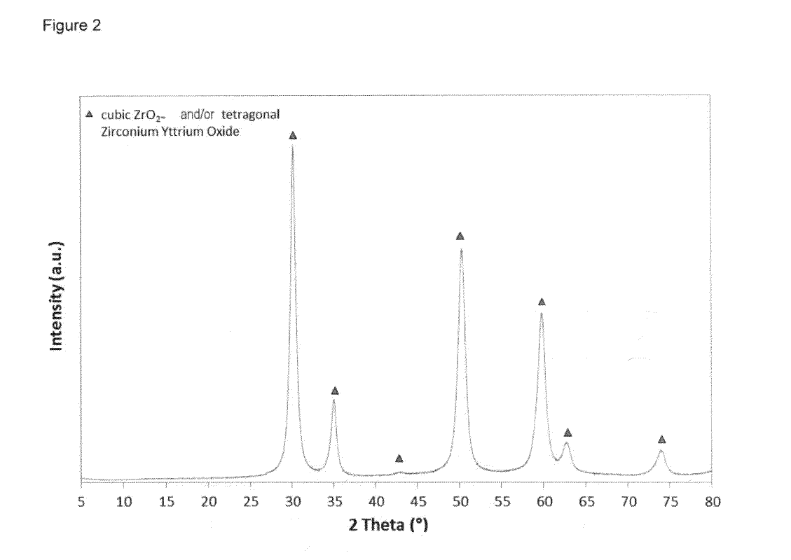

FIG. 2 shows the X-ray diffraction pattern recorded on catalyst sample S3 in the unreduced form, in which no reflections of an iridium oxide-comprising phase are to be found.

The determination of the average particle size of the iridium particles was carried out by evaluation of the X-ray diffraction patterns. In catalyst sample S2, which was loaded with 1% by weight of iridium (stabilized by yttrium), the iridium oxide particles (IrO₂) had an average crystallite size of 8.0 nm. An evaluation of the XRD data shown in FIG. 1 followed. Here, the iridium particles were present in the oxidic form since XRD analyses of the catalysts in the unreduced form have been carried out. Evaluation of the diffraction pattern shown in FIG. 2 indicated that no iridium oxide phase could be detected. This demonstrates that the iridium particles are smaller than 1 or 2 nm, since otherwise corresponding reflections would have to be able to be found in the XRD.

The XRD analyses were carried out by means of a D8 Advance Series 2 from Bruker/AXS using a CuK-alpha source (having a wavelength of 0.154 nm at 40 kV and 40 mA) and theta-2theta geometry (Bragg-Brentano geometry) in the reflection mode. The measurements were carried out over the measurement range: 5-80° (2theta), 0.02° steps at 4.8 seconds/step. The structure analysis software TOPAS (Bruker AXS) was used for determining the average crystallite sizes of the individual phases.

### Catalytic Studies

The catalytic studies on the reforming of a hydrocarbon-comprising gas in the presence of CO₂ were carried out by means of a catalyst test set-up equipped with six reactors connected in parallel. To prepare for the studies, the individual reactors were each charged with 20 ml of catalyst samples.

An overview of the catalytic studies carried out is shown in tables 2 and 3. Firstly, the reactors charged with the catalysts were heated in a controlled manner under a carrier gas atmosphere from 25° C. to the target temperature. Nitrogen was used as carrier gas. (It is conceivable to carry out heating in the presence of a reducing gas atmosphere.) A heating rate of 10° C./min was selected for heating the reactors. After the reactors with the catalysts had been maintained at the target temperature in the stream of nitrogen for 0.5 h, they were supplied with the reforming gas.

In the catalytic studies, the individual samples were subjected to a sequence of different test conditions. In the first two test conditions of the sequence, the catalysts were maintained at 950° C. and the water vapor content of the reforming gas was reduced stepwise from 10% by volume to 0% by volume. In the tables below, the studies carried out at 950° C. in the presence of 10% by volume and 0% by volume of water vapor are denoted by the suffixes c1 and c2 (i.e. c1 corresponds to 10% by volume of water vapor at 950° C. and c2 corresponds to 0% by volume of water vapor at 950° C.). The samples tested at 850° C. in the presence of 0% by volume of water vapor are denoted by the suffix c3 in table 3. In the case of the test conditions in the presence of 10% by volume of water vapor (c1), the samples were subjected to a lower space velocity that in the case of test conditions in the absence of water vapor in the feed fluid (c2 and c3).

All catalytic studies were carried out in the presence of 5% by volume of argon as internal standard; this was added to the feed fluid for analytical reasons in order to monitor the recovery rates of material.

The test conditions selected here were so demanding in terms of the physicochemical conditions that it was possible to achieve high conversions and stable performance properties over a prolonged period of time only by means of the catalyst samples according to the invention (table 2). This can be seen from the fact that the comparative samples CE1, CE3 and CE4, in which the iridium was present on alpha-aluminum oxide and in which the iridium loadings were in the range from 0.5 to 2% by weight, were completely deactivated or coked within a few hours at 10% by volume of H₂O in the feed. Similarly rapid deactivation or coking in the presence of 10% by volume of H₂O in the feed was also observed for the comparative sample CE2 in which 1% by weight of iridium was present on an undoped monoclinic zirconium dioxide. The comparative sample CE5, which had 1% by weight of Pt and otherwise the same composition of the remaining components as S1 and S4, displayed stable performance properties at 850° C. and 10% by volume of H₂O in the feed but deactivated very severely over a period of 43 hours, after which the water content was reduced to 0% by volume (table 3).

In contrast to the comparative examples, the catalysts according to the invention of examples S1 to S4, which were used in combination with the process of the invention and were tested in the presence of 10% by volume and finally 0% by volume of water vapor, displayed no deactivation and a very high conversion of CO₂ and CH₄.

It is remarkable that the catalysts according to the invention displayed a high catalytic activity under the very demanding conditions and maintained this even after a very long period of more than 485 hours (cumulative), as can clearly be seen from the test results for catalyst S3 (table 4).

After the catalytic tests, the catalysts removed from the reactors were subjected to analyses to determine the amount of carbonaceous material. It was found that the catalysts according to the invention had no carbonaceous deposits even after the catalysis tests. This demonstrated the high carbonation resistance of the catalysts of the invention.

In all studies on S1 to S4, a synthesis gas having an H₂/CO ratio of ≦1 was produced. The lower the water vapor content in the reforming gas, the higher is the conversion of CO₂ relative to the conversion of CH₄. Particularly in dry reforming, the synthesis gas had an H₂/CO ratio of less than 0.9 and sometimes also less than 0.8.

Table 1 shows a summary of the composition of the active compositions tested and the metal content.

| | Metal content | | | Stabilizer content |
|---|---|---|---|---|
| Sample | [% by wt.] | Support | Stabilizer | [% by wt. as oxide] |
| S1 | 2 | ZrO₂ | Ce, La | 22 |
| S2 | 1 | ZrO₂ | Y | 8 |
| S3 | 0.1 | ZrO₂ | Y | 8 |
| S4 | 0.1 | ZrO₂ | Ce, La | 22 |
| CE1 | 1 | Al₂O₃ | — | |
| CE2 | 1 | ZrO₂ | — | |
| CE3 | 0.5 | Al₂O₃ | — | |
| CE4 | 2 | Al₂O₃ | — | |
| CE5 | 1 (Pt) | ZrO₂ | Ce, La | 22 |

Table 2 shows the chemical constitution of the product stream obtained in the CO₂ reformation of CH₄ under different experimental conditions in respect of the water vapor content. The reforming gas used had an equimolar ratio of CH₄ and CO₂ and 5% by volume of argon as internal standard. All experiments were carried out at a temperature of 950° C. and a reactor pressure of 20 bar. The values denoted by “start” were recorded immediately at the beginning of each experiment; the values denoted by “end” were recorded after a TOS (time on stream) of 43 hours. The notation (*) indicates that carbonaceous deposits were formed on the samples after lowering of the water vapor content and led to blockage/malfunction of the reactor.

| | CH₄ | CH₄ | CO₂ | CO₂ | | |
|---|---|---|---|---|---|---|
| | conv. | conv. | conv. | conv. | | |
| | (start) | (end) | (start) | (end) | H₂/CO | H₂/CO |
| Sample | [%] | [%] | [%] | [%] | (start) | (end) |
| S1_c1 | 80 | 80 | 80 | 80 | 0.9 | 0.9 |
| S2_c1 | 82 | 82 | 83 | 83 | 0.9 | 0.9 |
| S3_c1 | 82 | 80 | 82 | 82 | 0.9 | 0.9 |
| S4_c1 | 82 | 82 | 84 | 84 | 0.9 | 0.9 |
| CE1_c1 | 70 | 13 | 71 | 9 | 1.0 | 2.8 |
| CE2_c1 | 70 | 59 | 74 | 67 | 0.9 | 0.9 |
| CE3_c1 | 75 | 33 | 80 | 45 | 1.0 | 0.75 |
| CE4_c1 | 76 | 13 | 80 | 9 | 1.0 | 2.5 |
| S1_c2 | 73 | 75 | 85 | 87 | 0.8 | 0.8 |
| S2_c2 | 75 | 75 | 88 | 88 | 0.8 | 0.8 |
| S3_c2 | 35 | 35 | 45 | 51 | 0.6 | 0.5 |
| CE1_c2 | 22 | 0* | 19 | 0* | / | / |
| CE2_c2 | 20 | 0* | 15 | 0* | / | / |
| CE3_c2 | 20 | 0* | 18 | 0* | / | / |
| CE4_c2 | 15 | 0* | 11 | 0* | / | / |

c1: feed gas: CH₄:CO₂:H₂O:Ar = 42.5:42.5:10:5 (% by vol.); T = 950° C., p = 20 bar
c2: feed gas: CH₄:CO₂:H₂O:Ar = 47.5:47.5:0:5 (% by vol.); T = 950° C., p = 20 bar

Table 3 shows the results achieved in the studies on catalyst samples S2 and CE5 under test conditions c3. The values denoted by “start” were recorded immediately at the beginning of each experiment; the “end” values were recorded after a TOS (time on stream) of 43 hours. The catalytic measurements were carried out at 850° C.

| | CH₄ | CH₄ | CO₂ | CO₂ | | |
|---|---|---|---|---|---|---|
| | conv. | conv. | conv. | conv. | | |
| | (start) | (end) | (start) | (end) | H₂/CO | H₂/CO |
| Sample | [%] | [%] | [%] | [%] | (start) | (end) |
| S2_c3 | 55 | 55 | 73 | 73 | 0.7 | 0.7 |
| CE5_c3 | 50 | 35 | 64 | 51 | 0.7 | 0.4 |

Table 4 shows the results obtained in the study on catalyst sample S3 after a TOS (time on stream) of 235 h and 254 h under test conditions c1 (10% by volume of H₂O) and c2 (0% by volume of H₂O). The catalytic measurements were carried out at a temperature of 950° C. and a pressure of 20 bar.

| | CH₄ conv. | CO₂ conv. | | TOS |
|---|---|---|---|---|
| Sample | [%] | [%] | H₂/CO | [h] |
| S3_c1 | 80 | 82 | 0.9 | 235 |
| S3_c2 | 58 | 79 | 0.7 | 254 |

1. A catalyst, comprising an active composition comprising an iridium-containing active component and a zirconium dioxide-containing support material,
wherein:
an iridium content based on a content of the active composition is in the range of 0.0110% to 5% by weight; and
b) the zirconium dioxide in the zirconium dioxide-containing support material predominantly has a cubic and/or tetragonal structural form, where a proportion of cubic and/or tetragonal phase is >50% by weight.

2. The catalyst according to claim 1, wherein:
the zirconium dioxide-containing support material comprises additional components; and
a proportion of the tetragonal and/or cubic zirconium dioxide based on a total weight of the support is >80% by weight.

3. The catalyst according to claim 1, wherein the zirconium dioxide-containing support material has a specific surface area of >5 m²/g.

4. The catalyst according to claim 1, wherein the active composition further comprises a dopant comprising one or more elements selected from the group consisting of Sc, Y, La, Ce, Pr, Nd, Sm, Eu, Gd, Tb, Dy, Ho, Er, Tm, Yb, Lu, Mg, Ca, Sr, Ba, Ti, Hf, V, Nb, Ta and Si, such that a proportion of doping elements based on an amount of the active composition is in the range 0.01-80% by weight.

5. The catalyst of claim 1, wherein the active composition further comprises a dopant comprising one or more elements selected from the group consisting of Sc, Y, La, Ce, Pr, Nd, Sm, Eu, Gd, Tb, Dy, Ho, Er, Tm, Yb, and Lu, such that a proportion of doping elements based on a proportion of the active composition is in the range 0.01-80% by weight.

6. The catalyst of claim 1, wherein the support material comprises yttrium as a doping element or the support material comprises La and/or Ce as doping elements.

7. The catalyst of claim 1, wherein the active composition further comprises at least one noble metal-comprising promoter selected from the group consisting of Pt, Rh, Pd, Ru, Au, which is present in an amount in the range 0.01-5% by weight.

8. The catalyst of claim 1, wherein the active composition further comprises at least one base metal-containing promoter selected from the group consisting of Ni, Co, Fe, Mn, Mo and W, which is present in an amount in the range 0.1-50% by weight.

9. The catalyst of claim 1, wherein the active composition further comprises at least one further metal cation species selected from the group consisting of Mg, Ca, Sr, Ga, Be, Cr, and Mn.

10. A high-pressure process for CO₂ reforming of hydrocarbons to produce synthesis gas, the process comprising contacting a reforming gas with a catalyst comprising an iridium-containing active composition,
wherein:
(i) a total content of hydrocarbons and CO₂ in the reforming gas is greater than 80% by volume;
(ii) a pressure of the reforming gas on contacting with the active composition is in the range of 5-500 bar, and a temperature of the reforming gas on contacting with the active composition is in the range from 600 to 1200° C.;
(iii) a GHSV in the process is in the range from 500 to 100 000 h⁻¹; and
(iv) a synthesis gas produced by the process has an H₂/CO ratio in the range from 0.4 to 1.8.

11. The high-pressure process according to claim 10, wherein at least one of the following is satisfied:
the iridium-containing active composition is present in combination with ZrO₂, such that a Ir content based on ZrO₂ is in the range 0.01-10% by weight;
zirconium dioxide in the zirconium dioxide-containing support material predominantly has a cubic and/or tetragonal structure, such that a proportion of cubic and/or tetragonal phase is >50% by weight.

12. The high-pressure process according to claim 10, wherein the active composition comprises at least one rare earth element.

13. The high-pressure process according to claim 10, wherein the reforming gas comprises only small amounts of H₂O, with the steam/carbon ratio in the reforming gas being less than 0.2.

14. The high-pressure process according to claim 10, wherein the iridium-containing active composition is provided with promoters.

15. The high-pressure process according to claim 10, wherein the reforming gas used is free of H₂O.

16. The catalyst according to claim 2, wherein the zirconium dioxide-containing support material has a specific surface area of >5 m²/g.

17. The high-pressure process according to claim 11, wherein the active composition comprises at least one rare earth element
